(19) United States
(12) Patent Application Publication
(10) Pub. No.: US 2026/0062345 A1
(43) Pub. Date: Mar. 5, 2026

(54) COATED GLASS SUBSTRATE AND METHOD FOR MAKING THE SAME

(71) Applicant: AGC GLASS EUROPE, Louvain-la-Neuve (BE)

(72) Inventor: Valentin GOFFINET, Gosselies (BE)

(73) Assignee: AGC GLASS EUROPE, Louvain-la-Neuve (BE)

(21) Appl. No.: 19/103,659

(22) PCT Filed: Oct. 3, 2023
(86) PCT No.: PCT/EP2023/077330

§ 371 Date: Feb. 13, 2025

(30) Foreign Application Priority Data
Oct. 5, 2022 (EP) 22199899.0

(51) Int. Cl. C03C 17/36

(52) U.S. Cl. CPC C03C 17/366; C03C 17/3626; C03C 17/3644; C03C 17/3681; C03C 2217/216; C03C 2217/256; C03C 2217/281; C03C 2217/479; C03C 2217/94; C03C 2218/156

(57) ABSTRACT

A glazing includes a glass substrate having, on at least one major surface of the glass substrate, a coating that includes an alternating arrangement of n silver infrared radiation reflecting functional layers and n+1 dielectric coatings, with n≥1, such that each functional layer is surrounded by dielectric coatings. At least one dielectric coating is in direct contact with at least one infrared reflecting functional layer and includes, at a distance of up to 10 nm from the at least one infrared reflecting functional layer, silver nanoparticles having a diameter ranging from 1 to 5 nm.

### TECHNICAL FIELD

The present invention relates to coated glass substrates, comprising silver layers and having improved chemical resistance. The invention also relates to a process for manufacturing such coated glass substrates.

The coated glass substrates of the present invention may be used as insulation glazings and/or solar control glazings. These glazings are intended equally for installation in buildings and in vehicles. They aim in particular to reduce the air-conditioning effort and/or to reduce excessive overheating (so-called “solar control” glazings) and/or to reduce the amount of energy dissipated to the outside (so-called “low-emission” glazings).

### BACKGROUND ART

A large number of coatings for use on glass substrates rely on one or more silver comprising layers to provide reflection of infrared light so as to enhance the glazings insulating and/or solar control properties. Such silver comprising layers are generally sandwiched in between dielectric coatings comprising one or more individual layers of oxides, nitrides or oxynitrides that help to protect the silver layer and improve the optical properties in particular regarding desired reflectance and regarding color. Chemical resistance of such glazings is generally improved by the addition of certain layers over the silver layer, for example layers comprising silicon nitride or mixed oxides of zinc and tin.

US20208139935 A1 discloses a multilayer coating of alternating hydrogenated metal nitride layers and silver layer(s) wherein Ag nanoparticles of undisclosed size diffuse from the underlying Ag layer into the overlying dielectric by thermal or optical treatment, resulting in improved electrical conductivity. Here Ag diffusion happens almost throughout the whole overlying dielectric, no improvement in chemical resistance is shown and nanoparticle sizes are not reported.

It has been found that these coatings still have limited chemical durability.

### SUMMARY OF INVENTION

It is an object of the present invention to provide coated glass substrates having good chemical resistance. The present invention in particular concerns coatings on glass substrates comprising one or more layers deposited by magnetron sputtering.

The present invention is based on the discovery that it was possible to significantly increase the chemical resistance of coated glass substrates by subjecting them to ion implantation, where the coating comprises an alternating arrangement of n infrared reflecting functional layers comprising silver, and n+1 dielectric coatings, with n≥1, such that each functional layer is surrounded by dielectric coatings and at least one dielectric coating is in direct contact with at least one infrared radiation reflecting functional layer. Said at least one dielectric coating in direct contact with at least one infrared radiation reflecting functional layer was found to comprise, at a distance of up to 10 nm from the infrared radiation reflecting functional layer, silver nanoparticles having a diameter ranging from 1 to 5 nm. The coatings according to the present invention maintain electrical conductivity.

The present invention therefore relates to a glazing comprising a glass substrate and comprising, on at least one major surface of the glass substrate, a coating comprising an alternating arrangement of n infrared radiation reflecting functional layers comprising silver, and n+1 dielectric coatings, with n≥1, such that each functional layer is surrounded by dielectric coatings, wherein at least one dielectric coating is in direct contact with at least one infrared reflecting functional layer and comprises, at a distance of up to 10 nm from said at least one infrared reflecting functional layer, silver nanoparticles having a diameter ranging from 1 to 5 nm.

The presence of silver nanoparticles was confirmed by transmission electron microscope (TEM) images taken of a cross-section of the coated substrate. The nanoparticles appear essentially circular and the diameter is the cross-sectional equivalent diameter as determined on the TEM images. The cross-sectional equivalent circular diameter of a nanoparticle, if it has an irregular shape, is the diameter of a two-dimensional disk having an equivalent area to the cross-section of the nanoparticle, for example determined by an image analysis method. The TEM images may for example be processed with the image analysis software ImageJ (developed by the National Institutes of Health, USA) to determine particle sizes for example.

To the best of our knowledge the ion implantation may play a double role in the formation of silver nanoparticles, first by enhancing diffusion of silver into the surrounding layers and second by giving mobility to the layers' components allowing for the reorganization of the silver into larger nanoparticles.

For clarification, the fact that silver nanoparticles are found at a distance of up to 10 nm from the infrared radiation reflecting functional layer means that they are found at a distance of up to 10 nm at most, but not more than 10 nm.

The present invention further concerns a process for improving the corrosion resistance of a coated glass substrate. The process may comprise the following operations:
a. providing a glass substrate comprising on a major surface a coating comprising an alternating arrangement of n infrared radiation reflecting functional layers comprising silver, and n+1 dielectric coatings, with n≥1, such that each functional layer is surrounded by dielectric coatings, wherein at least one dielectric coating is in direct contact with at least one infrared reflecting functional layer;
b. providing a source gas selected from O₂ or N₂, He, Ne, Ar, or Kr;
c. ionizing the source gas so as to form ions of O, N, He, Ne, Ar, or Kr;
d. accelerating the ions of O, N, He, Ne, Ar, or Kr with an acceleration voltage so as to form an ion beam,
e. positioning the glass substrate part in the trajectory of the beam of ions of O, N, He, Ne, Ar, or Kr with the coating facing the beam and setting the acceleration voltage at a value of at least 5 kV and 100 kV, so as to implant the ions throughout said at least one infrared reflecting functional layer.

Advantageously, the acceleration voltage is set at a value selected between 5 kV and 100 kV. Acceleration voltages of more than 100 kV may also be successful but may lead to more complicated implantation apparatuses. More advantageously the acceleration voltage is set at a value of at least 10 kV, even more advantageously of at least 12 kV. Acceleration voltages above 100 kV were found to lead to a quick and complete degradation of silver comprising functional layers.

In a preferred embodiment the ions of O, N, He, Ne, Ar and KR are positively charged ions.

The present invention further concerns the use of implanted ions to improve the corrosion resistance of a glass substrate comprising on at least one major surface of the glass substrate a coating comprising an alternating arrangement of n infrared radiation reflecting functional layers comprising silver, and n+1 dielectric coatings, with n≥1, such that each functional layer is surrounded by dielectric coatings, wherein at least one dielectric coating is in direct contact with at least one infrared reflecting functional layer.

It is to be understood that in the context of the present invention, chemical resistance of the coated glass substrate is the chemical resistance of the coating on the glass substrate, illustrated using climatic chamber and neutral salt spray tests as described below.

The coating of the present invention may have a total geometrical thickness T of up to 300 nm. The total thickness T is preferably between 10 and 200 nm, more preferably between 20 and 100 nm, and in particular between 40 and 70 nm.

In certain embodiments, the coating of the present invention may be a solar control or an insulating lowE coating.

According to an embodiment of the present invention, the coating preferably comprises an alternating arrangement of n infrared radiation reflecting functional layers and n+1 dielectric coatings, with n=1, n=2, or n=3.

According to an embodiment of the present invention one or more or, in particular, all layers of the multilayer stack are deposited by magnetron sputtering.

In the coating of the present invention, the infrared radiation reflecting functional layers are silver comprising layers that may consist of silver or possibly be doped with palladium or gold, for example, in a proportion of 5% by weight at most, preferably of around 1% by weight. The incorporation of a small quantity of doping agent in the silver-based layer may improve the chemical stability of the stack.

The inventors have found that in chemical resistance tests, defects are frequently related to a delamination occurring at an interface between a silver-based layer and a contacting layer, for example a dielectric layer.

### DESCRIPTION OF EMBODIMENTS

The infrared radiation reflecting functional layers advantageously have a thickness of at least 6 nm or at least 8 nm, preferably at least 9 nm. Their thickness is preferably 22 nm at most or 20 nm at most, more preferably 18 nm. These thickness ranges may enable the desired low emissivity and solar control function to be achieved while retaining a good light transmission. In a coating stack with two functional layers it may be preferred that the thickness of the second functional layer, that furthest away from the substrate, is slightly greater than that of the first to obtain a better selectivity. In the case of a coating stack with two functional layers, the first functional layer may have a thickness, for example, of between 8 and 18 nm and the second functional layer may have a thickness between 10 and 20 nm.

In a coating of the present invention a dielectric coating may comprise one or more layers which are each made of a dielectric material, of the metal nitride, metal oxide or metal oxynitride type. From an optical point of view, the purpose of these coatings that frame the metallic functional layer is to “anti-reflect” this metallic infrared reflecting functional layer.

In a multilayer stack in the present invention sacrificial metallic or suboxidized barrier layers may be provided in contact with one or more infrared reflecting functional layers, above and/or below said functional layers, to prevent their degradation during the deposition process and/or during tempering or bending. Such sacrificial barrier layers are for the purpose of the present invention not considered part of a dielectric coating.

In a multilayer stack in the present invention, dielectric seed or barrier layers, in particular zinc oxide layers, advantageously aluminum doped zinc oxide layers, may be deposited by magnetron sputtering so as to be in direct contact with one or more infrared reflecting functional layers, above and/or below said functional layers, to promote crystalline growth of the metallic functional layers (seed layer), and/or prevent their degradation during the deposition process and/or during tempering or bending (barrier layer). For the purpose of the present invention, these dielectric seed or barrier layers are considered to be part of the corresponding dielectric coating above or below a functional layer.

The multilayer stack in the present invention may a part of a larger multilayer coating with additional layers being added after the implantation of ion in the multilayer stack.

When speaking of implantation depth, it is to be understood that the depth is measured from the outer surface of the coating, going towards the bulk of the substrate. Further, the maximum depth of implanted ions Dmax may be greater or smaller than the thickness T of the coating.

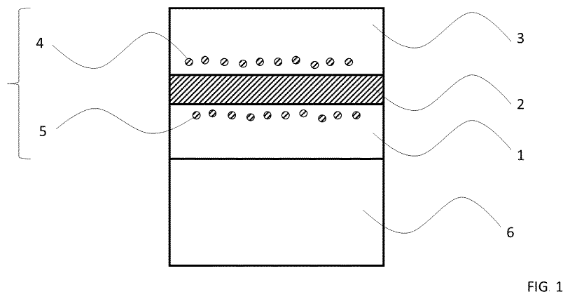

FIG. 1 shows, a schematic illustration of a glass substrate (6) comprising on at least one major surface a coating (7) comprising an alternating arrangement of n=1 infrared radiation reflecting functional layers comprising silver (2), and n+1=2 dielectric coatings (1, 3), functional layer (2) is surrounded by dielectric coatings (1, 3). Both dielectric coatings (1, 3) are in direct contact with infrared reflecting functional layer (2) and comprise silver nanoparticles (4, 5). at a distance of up to 10 nm from the infrared reflecting functional layer (2), silver nanoparticles (4, 5) having a diameter ranging from 1 to 5 nm.

In general, but not limiting to the description of the present invention, the glass substrate may usually be of soda-lime-silicate glass, in particular clear or extra-clear glass. As is however appreciated by those skilled in the art, the substrate may be of other types of glass, such as boro-silicate glass or alumina-silicate glass. The glass substrate may also be colored or absorbing, even almost opaque in the visible light range.

In an embodiment the glazing of the present invention, comprises in the coating implanted ions selected from ions of O, N, He, Ne, Ar, or Kr. Heavier ions were found to lead to a quick and complete degradation of silver comprising functional layers.

The implanted ions are preferably positively charged ions.

The implanted ions are preferably implanted in the coated substrate up to a depth Dmax comprised between 0.1 μm and 1 μm, starting from the outer surface of the coating.

The amount per surface unit or dosage of implanted ions is preferably comprised between 5×10¹⁴ ions/cm² and 10¹⁸ ions/cm², advantageously between 10¹⁶ ions/cm² and 5×10¹⁷ ions/cm², more advantageously between 3×10¹⁶ ions/cm² and 10¹⁷ ions/cm². The ion dosage may for example be controlled by the duration of exposure to the ion beam and also depends on the ion current of the ion beam. At lower dosages no durability improvement may be observed. At higher dosages the coating may be damaged.

It has been surprisingly found that the implanted ions may reduce the amount of defects appearing in the coating, in particular defects appearing in durability tests described below.

In an embodiment of the present invention the trajectory of the ion beam is essentially perpendicular to the surface of the glass substrate.

In certain embodiments the glass substrate is moved relative to the ion beam in order to treat its entire surface in a single pass or in multiple passes. The glass substrate part may be moved at speeds comprised between 20 and 160 mm/s.

The inventors have found that advantageously ion sources providing an ion beam comprising a mixture of single charge and multicharge ions are used to ionize the source gas. Such ion mixtures, accelerated with the same acceleration voltage are particularly useful as they may provide higher fluences than single charge ion beams. They are therefore able to reach a certain dosage in a shorter amount of time. Multiple charge ions are also interesting because they reach greater implantation depths than single charge ions, for the same acceleration voltage. The implantation energy, expressed in Electron Volt (eV) is calculated by multiplying the charge of the single charge ion or multicharge ion with the acceleration voltage. An ion beam comprising a mixture of single charged ions and multi charged ions are particularly useful as for a certain acceleration voltage, a double charged ion of a certain species, for example N²⁺, will have double the implantation energy of the corresponding single charge ion, N⁺. Thereby greater implantation depths can be reached without having to increase the acceleration voltage. According to an advantageous embodiment of the present invention the, preferably positively charged, ions comprise a mixture of single and/or multiple charged ions. As for a given acceleration voltage, ions are provided with an energy proportional to their charge, a mixture of single charge and multiple charged ions enables the implantation over a wider depth range in a single step than with single charge ions. More advantageously, in a mixture of single and multiple charged ions the relative amounts of the differently charged ions decreases with increasing charges. Thereby the amount of implanted ions may decrease when going from the coated substrate surface towards the bulk.

In an embodiment of the present invention at least 90% of the ions in the ion beam are made up of the single charge and double charge ions of a species selected from N, O, He, Ne, Ar, Kr and the ratio of single charge species to double charge species is at least 55/25. The respective single charge and double charge species are N⁺ and N²⁺, O⁺ and O²⁺, He⁺ and He²⁺, Ne⁺ and Ne²⁺, Ar⁺ and Ar²⁺.

In an alternate embodiment, ions are implanted by implanting sequentially the selected ions as monocharged ions, for example in two or more steps of differing acceleration voltages.

In a preferred embodiment of the present invention the temperature of the area of the glass substrate being treated, situated under the area being treated is less than or equal to the glass coalescence temperature of silver. This temperature is for example influenced by the ion current of the beam, by the residence time of the treated area in the beam and by any cooling means for the substrate.

In an advantageous embodiment of the invention implanted ions of either He, N or O are used as they show less coating surface sputtering than heavier ions, which is particularly important to maintain the coating and it's opto-energetical properties intact. In another embodiment of the invention implanted ions of N and O are combined.

In another advantageous embodiment of the invention implanted ions of either Ar are used as similar performance as with implantation of N ions can be reached with lower dosage.

In one embodiment of the invention several ion implantation beams are used simultaneously or consecutively to treat the glass substrate.

In one embodiment of the invention the total dosage of ions per surface unit of an area of the glass substrate is obtained by a single treatment by an ion implantation beam.

In another embodiment of the invention the total dosage of ions per surface unit of an area of the glass substrate is obtained by several consecutive treatments by one or more ion implantation beams. The ion beams may use the same or different source gases to implant the same or different ions of O, N, He, Ne, Ar, or Kr.

The method of the present invention is preferably performed in a vacuum chamber at a pressure comprised between 10⁻² mbar and 10⁻⁷ mbar, more preferably at a pressure comprised between 5×10⁻⁵ mbar and 6×10⁻⁶ mbar.

An example ion source for carrying out the method of the present invention is the Hardion+ ECR ion source from Ionics SA.

Advantageously the implantation depth Dmax of the ions may be comprised between 0.1 μm and 1 μm, preferably between 0.1 μm and 0.5 μm. The implanted ions are spread between the substrate surface and the implantation depth. The implantation depth may be adapted by the choice of implanted ion, by the acceleration energy, by the angle of irradiation and varies to a certain degree depending on the substrate.

According to the present invention, the mixture of single charge and multicharge ions of O or N preferably comprises, O⁺ and O²⁺ or N⁺, N²⁺ and N³⁺ or Ar⁺ and Ar²⁺ respectively.

According to a preferred embodiment of the present invention, the mixture of single charge and multicharge ions of O comprises a lesser amount of O²⁺ than of Ot. In a more preferred embodiment of the present invention the mixture of single charge and multicharge ions of O comprises 55 to 98% of O⁺ and, 2 to 45% of O²⁺.

According to another preferred embodiment of the present invention, mixture of single charge and multicharge ions of N comprises a lesser amount of N³⁺ than of N⁺ and of N²⁺ each. In a more preferred embodiment of the present invention the mixture of single charge and multicharge ions of N comprises 40 to 70% of N⁺, 20 to 40% of N²⁺, and 2 to 20% of N³⁺.

According to another preferred embodiment of the present invention, mixture of single charge and multicharge ions of Ar comprises a lesser amount of Ar²⁺ than of Ar⁺. In a more preferred embodiment of the present invention the mixture of single charge and multicharge ions of Ar comprises 50 to 80% of Ar⁺, 10 to 30% of Ar²⁺, and 3 to 15% of Ar³⁺.

Chemical durability of the coated glass substrates is tested using a climatic chamber test and a salt fog test.

The Neutral Salt Spray test, in accordance with standard EN 1096-2012, consists in subjecting the coated glass to a salt spray formed by distilled water with dissolved NaCl. Temperature conditions are 35+/−2° C. The test duration is 10 days.

Climatic chamber test (CC): The test consists in placing the samples in a chamber filled with a water saturated atmosphere of H2O and subjected to temperature cycles each of 2 hours, during which the temperature varies from 45° C. to 55° C. returning to 45° C. The test duration is 10 days.

Salt fog test (NSST): This test consists in subjecting the sample to the action, in a chamber maintained at 35° C., of a salt fog formed by spraying an aqueous solution containing 50 g/l sodium chloride (full details of this test are set out in International Standard ISO 9227-2001), until first defects appear.

Glass substrates A and B were implanted with ions. These glass sheets bear coatings, deposited by magnetron sputtering on a major surface. The layer sequences of the coatings of the different substrates are detailed in table 1 below.

TABLE 1

Substrate

| | |
|---|---|
| A | B |

Glass

| | | |
|---|---|---|
| Dielectric coating | Zn₂SnO₄ | Zn2SnO₄ |
| | TZO | |
| | ZnO:Al | ZnO:Al |
| Functional layer | Ag | Ag |
| Sacrificial barrier | none | none |
| Dielectric coating | ZnO:Al | ZnO:Al |
| | Zn₂SnO₄ | Zn₂SnO₄ |
| | SiN | SiN |
| | TZO | TZO |

TZO is a mixed oxide of Ti and Zr, more preferably of a titanium-zirconium in a weight ratio of TiO₂/ZrO₂ of 65/35. SiN is Si₃N₄. All coatings were deposited on normal clear soda lime glass using magnetron sputtering. ZnO:Al is aluminum doped zinc oxide.

The glass substrates were implanted with mixtures of single and multicharged ions of He, Ar, N respectively. The dosage was varied between 10¹⁵ ions/cm² and 8×10¹⁶ ions/cm². The current of the ion beam was varied between 2 and 10 mA. Acceleration voltage was 40 kV. The implanted substrates maintain electrical conductivity, as ascertained by measuring the sheet resistance with a contactless measurement device Stratometer G from the company Nagy Messsysteme GmbH. The implanted glass substrates were subjected to climatic chamber and salt fog tests and the number of size of defects determined.

Detailed test results after ion implantation of Ar ions in A and B are shown in table 3. The test results are rated from 0 to 5, with 5 being not degraded and 1 being very much degraded. Without implantation A and B reach a test rating of 1.

Furthermore, substrates A and B were implanted with He and N ions, in dosage ranges and current ranges summarized in table 3.

For all implanted samples significant durability improvements were observed, especially as initial defects observed does not expand significantly in size during ageing tests. Also on ion implanted samples, cross-sectional TEM images show silver nanoparticles formed in the dielectric coating above and below the silver functional layer for both substrates A and B. The distance of these nanoparticles was <10 nm from the silver functional layer. The nanoparticles have an essentially circular cross section and the diameter was estimated at between 2 and 4 nm.

TABLE 2

| | | | beam | | |
|---|---|---|---|---|---|
| | | dosage | current | CC | NSS |
| Substrate | Gas | [×10¹⁵ ions/cm²] | [mA] | rating | rating |
| B | Ar | 1 | 6 | 3, 5 | 2 |
| B | Ar | 2 | 6 | 3, 5 | 2 |
| B | Ar | 4 | 6 | 3, 5 | 2, 8 |
| B | Ar | 6 | 6 | 3 | 4 |
| B | Ar | 20 | 6 | 3 | 4 |
| B | Ar | 80 | 6 | 4 | 1 |
| A | Ar | 1 | 6 | 3, 5 | 2, 5 |
| A | Ar | 2 | 6 | 3 | 3 |
| A | Ar | 4 | 6 | 3 | 3, 7 |
| A | Ar | 6 | 6 | 3 | 3 |
| A | Ar | 20 | 6 | 2 | 2 |
| A | Ar | 80 | 6 | 4 | 2 |

TABLE 3

| | | | beam | | |
|---|---|---|---|---|---|
| | | dosage | current | CC | NSS |
| Substrate | Gas | [×10¹⁵ ions/cm²] | [mA] | rating | rating |
| B | He | 1 to 10 | 2 to 10 | 3 to 4 | 2 to 3 |
| B | N2 | 5 to 10 | | 3 to 5 | 4 to 5 |
| A | He | 1 to 10 | | 2 to 3 | 2 to 3 |
| A | N2 | 5 to 10 | | 2 to 3 | 3 to 4 |

1. A glazing comprising a glass substrate and comprising, on at least one major surface of the glass substrate, a coating comprising an alternating arrangement of n infrared radiation reflecting functional layers comprising silver, and n+1 dielectric coatings, with n≥1,
wherein each functional layer is surrounded by dielectric coatings,
wherein at least one dielectric coating is in direct contact with at least one infrared reflecting functional layer and the at least one dielectric coating comprises, at a distance of up to 10 nm from said at least one infrared reflecting functional layer, silver nanoparticles having a diameter ranging from 1 to 5 nm.

2. The glazing according to claim 1, wherein the infrared radiation reflecting functional layers have a thickness of at least 6 nm and/or 22 nm at most.

3. The glazing according to claim 1, wherein the coating has a total geometrical thickness T of up to 300 nm.

4. The glazing according to claim 1, wherein the glass substrate is selected among a soda-lime-silicate glass substrate, a boro-silicate glass substrate, and an alumina-silicate glass substrate.

5. The glazing according to claim 1, further comprising in the coating implanted ions selected from ions of O, N, He, Ne, Ar, and Kr.

6. The glazing according to claim 5, wherein the implanted ions are positively charged ions.

7. The glazing according to claim 5, wherein the implanted ions are implanted in the coated glass substrate up to a depth Dmax of from 0.1 μm to 1 μm, starting from an outer surface of the coating.

8. The glazing according to claim 5, wherein a dosage of implanted ions is from 5×10¹⁴ ions/cm² to 8×10¹⁶ ions/cm².

9. A process for improving the corrosion resistance of a coated glass substrate, comprising:
a. providing a glass substrate comprising on a major surface a coating comprising an alternating arrangement of n infrared radiation reflecting functional layers comprising silver, and n+1 dielectric coatings, with n≥1, such that each functional layer is surrounded by dielectric coatings, wherein at least one dielectric coating is in direct contact with at least one infrared reflecting functional layer;
b. providing a source gas selected from O₂ or N₂, He, Ne, Ar, or Kr;
c. ionizing the source gas so as to form positively charged ions of O, N, He, Ne, Ar, or Kr;
d. accelerating the positively charged ions of O, N, He, Ne, Ar, or Kr with an acceleration voltage so as to form an ion beam,
e. positioning the glass substrate in a trajectory of the beam of positively charged ions of O, N, He, Ne, Ar, or Kr with the coating facing the beam and setting an acceleration voltage at a value of from 5 kV to 100 kV, so as to implant the ions throughout said at least one infrared reflecting functional layer.

10. The process according to claim 9, wherein during the ionizing the source gas is ionized so as to form positively charged ions.

11. The process according to claim 9, wherein during the ionizing the source gas is ionized so as to form a mixture of single charge and multiple charge ions.

12. (canceled)

13. (canceled)
